(19) United States
(12) Patent Application Publication
(10) Pub. No.: US 2005/0089834 A1
(43) Pub. Date: Apr. 28, 2005

(54) Educational computer program

(76) Inventor: Jeffrey S. Shapiro, Weston, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 10/691,946

(22) Filed: Oct. 23, 2003

(51) Int. Cl. G09B 3/00; G09B 7/00

(52) U.S. Cl. 434/323

(57) ABSTRACT

A computer program is provided which intellectually stimulates a user during the running a base computer program. The secondary computer program interrupts the base computer program at set time intervals, providing questions to the user for answering. The user's answers are checked for correctness, where correct answers can result in the secondary computer program rewarding the user and incorrect answers can result in the secondary computer program penalizing the user.

### FIELD OF THE INVENTION

The present invention relates to educational software, and more particularly to a method and software for providing intellectual development while running a base computer program.

### BACKGROUND OF THE INVENTION

Studies have shown that the some children, with access to computers, tend to spend an exorbitant amount of time on the computer, for example, on the Internet or playing computer games. One such study suggested that some children spend on average 1-2 hours per day playing computer games on week days and 3-4 hours per day on weekends. On school holidays the number rose to as much a 4-5 hours per day. The study even suggested that some children spend as much as 15 hours per day playing computer games. These numbers are likely to increase as computers and computer games become more readily available.

While there are some suggested benefits to children play computer games, such as, an increased familiarity with technology and greater hand-eye coordination, children tend neglected other activities in their gaming pursuits. For example, it has been suggest that physical activities and school work tend to be neglected. However, with the increasing number of single and dual working parents it is becoming increasingly difficult for the parents to monitor their children's computer usage.

Accordingly, it would be desirable to have a computer program which would provide intellectual stimulation to user while the user is using the computer.

### SUMMARY OF THE INVENTION

The present invention provides a secondary computer program which intellectually stimulates a user while running a base computer program. The secondary computer program interrupts the base computer program at set time intervals. At the interruption, the secondary computer program provides questions to the user for answering. The user's answers are then checked for correctness. Correct answers can result in the secondary computer program rewarding the user. Incorrect answers can result in the secondary computer program penalizing the user.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is flow chart showing one methodology to implement the present invention;

FIG. 2 is a flow chart showing one embodiment of the computer program of the present invention;

FIG. 3 is a flow chart of the Question and Answer routine of the present invention; and

FIG. 4 is a flow chart of the Delay Question Routine of the present inventions.

### DETAILED DESCRIPTION OF THE INVENTION

The present invention provides a method and related computer program for providing intellectual development to a user while operating a computer. More specifically, a computer program is provided which periodically interrupts a base computer program to provide questions to a user for answering.

It is important to note that the embodiments of the invention described below are only examples of the several advantageous uses of the innovative teachings described herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. Please note that the order of the steps in the process may be changed to provide a more efficient system and method.

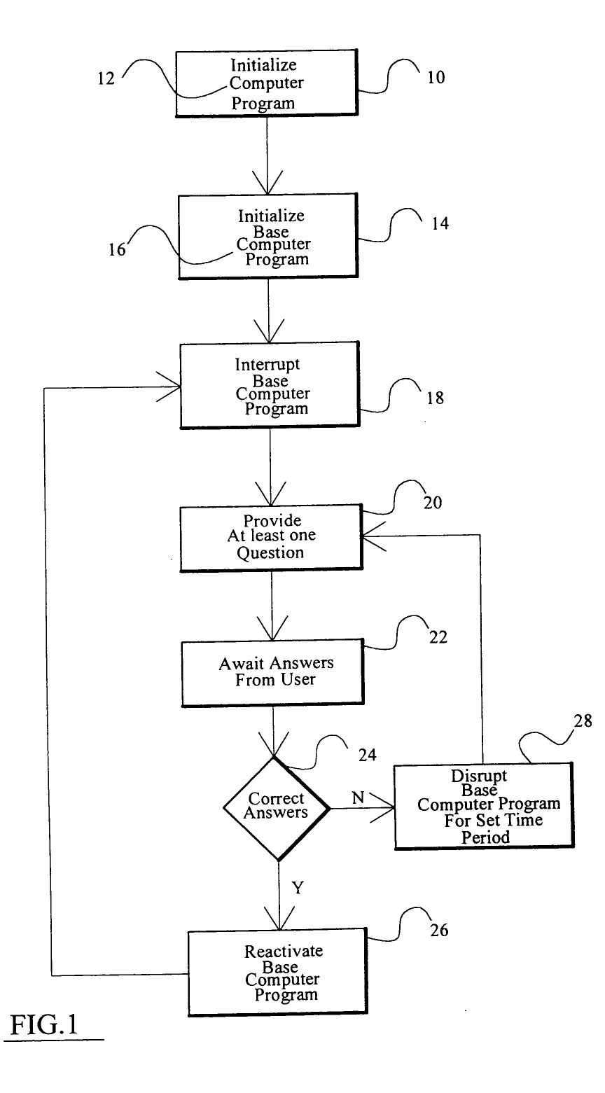

Referring now to the drawing figures in which like reference designators refer to like elements, there is shown in FIG. 1 a flow chart of the method of the present invention. The method includes initializing 10 the intellectual interruption (“II”) computer program 12 of the present invention and initializing and running 14 the base program 16. The II computer program 12 is initialized as set forth in Initialization Table 1.

### Initialization Table 1

A1. Require user to input his/her user name prior to running any base program—yes/no (Y/N).

A2. Input user name.

B1. List base programs to disrupt—Y/N.

B2. Input base programs (maybe automatic search of all base programs, display list to administrator, have administrator select “disrupt program” for the selection.

C. Input administrator user name; input password; confirm password.

D. Select age, topic questions for each user name.

E. Select interrupt time for each user.

F. Set bypass password.

G. Select type of disruption, blank screen, add more questions, flash screen, select time period for disruption.

H. Set ON/OFF “Delay Question” routine, progressive/static.

At a set time interval the II computer program 12 interrupts the base program 16, providing at least one question 20 to the user for answering. The II computer program 12 will await 22 an answer from the user before reactivating the base program 16. Answer time may be pre-set or may be selected by the Administrator upon initialization of program 12. If the correct answer 24 is received, or an acceptable percentage of correct answers are received, the base program 16 is reactivated 26. The II computer program 12 will continually interrupt 18 the base program 16 at set time intervals during the operation of the base program 16. If the correct answer 24 is not received the II computer program 12 will disrupt 28 the base program 16 for a set time period, after which at least one question 20 will be provided 20 to the user for answering. Other interruptions times may be programmed by the Administrator (the patent) who sets up the program 12.

Upon activation of the II computer program 12, the II computer program 12 can be initialized 14, An Administrator (typically, a parent) enters the Administrator's user name and password, providing the Administrator access to the II computer program 12 setup routine. The name of each user (typically, a child) is inputted. A listing of all base programs 16 for the users is entered. The listing of all base programs 16 can be manually entered or provided through an automatic search. From the list of base programs 16, the Administrator selects the base programs 16 to which the intellectual interruption II computer program 12 will apply for each user. The Administrator can periodically update the II computer program 12 by adding or removing users and base programs.

For each user (child), the age of the user and question topics are selected. A variety of topics are provided, which can include, but not be limited to, math, science, history, geography, reading, grammar, English, and foreign languages. Additionally, the questions are provided in a variety of skill levels which can initially depend on the age of the user. Optionally, the Administrator can set the skill level for each user.

The Administrator selects the interrupt time interval for each of the users. For example, an interrupt of fifteen minutes can be selected, wherein the II computer program 12 will interrupt the base program 16 (for example, AOL or AGE OF EMPIRES games) every fifteen minutes and present a set of questions. Additionally, the Administrator selects the disrupt time and the type of disrupt, for example a blank screen, a flashing screen, adds additional questions, etc. As such, if a user fails to correctly answer the questions, or an acceptable percentage of questions the II computer program 12 will disrupt the base program 16 for the selected disrupt time, after which additional questions will be provided to the user. A bypass password can be entered, which will allow the user to bypass the II computer program 12. The bypass password should be secret code controlled by the Administrator. The Administrator sets the “Delay Question” routine as either ON or OFF. The “Delay Question” routine enables the user to delay answering the questions for a set period of time, returning to the base program 16.

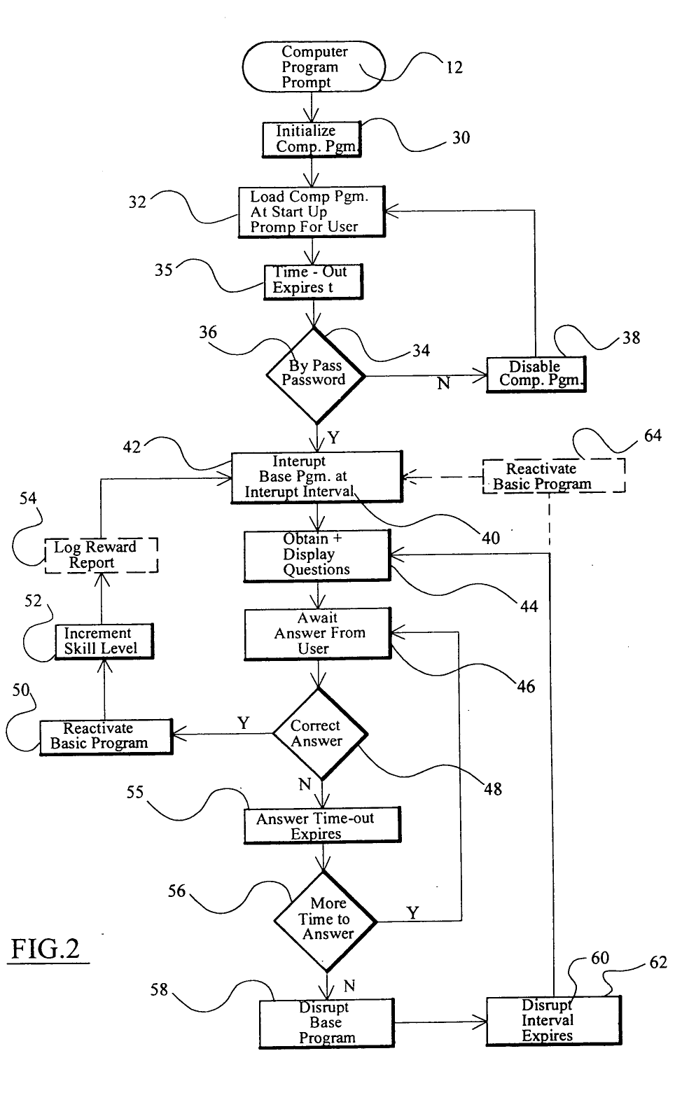

Referring to FIG. 2, after initialization 30 of the II computer program 12, the II computer program 12 is loaded 32 at computer start-up. The user is identified 32 by either entering the user's name or selecting the user's name for a list of users. Optionally, the user is prompted 34 to enter the Bypass Password 36. If the Bypass Password 36 is entered, the II computer program 12 is disabled 38 and the base program 16 is initiated. If the Bypass Password 36 is not entered, the II computer program 12 is enabled and the base program 16 is initiated.

At the set interrupt interval 40, the II computer program 12 interrupts 42 the base program 16. The II computer program 12 obtains the questions 44 for the user, based on the previously entered user information, and displays them. The questions can be displayed individually or in groups. The II computer program 12 will wait 46 a set answer period for the user (child) answer to the question. If the user correctly answers 48 the questions or an acceptable percentage of questions, the base program 16 is reactivated 50 until the next interrupt interval 40. The II computer program 12 will optionally increase the skill level 52 of the questions and create a report 54. Additionally, the interrupt time interval 40 can be increased (as a reward) after each set of correctly answered questions. It is also contemplated the II computer program 12 flags the questions that the user correctly answered so that they will not be provided to the user again.

If the user fails to correctly answer the questions within the question period (sometimes manually set at initialization, otherwise automatically set) or an acceptable percentage of questions, the user can request additional time to answer 56. Upon the expiration of the additional time 56 or the failure to answer the questions or an acceptable percentage of questions correctly, the II computer program 12 will disrupt 58 the base program 16 for the set disruption interval 60. After the expiration of the set disruption interval 62, a new set of questions is obtained 44 and presented to the user. This process will be repeated until the user correctly answers the question, an acceptable percentage of questions, or ends the base program 16.

Alternatively, after the expiration 58 of the set disruption interval 60, the base program 16 will be reactivated 64 until the next interrupt interval 40. Optionally, the II computer program 12 can decrease the interrupt interval 40.

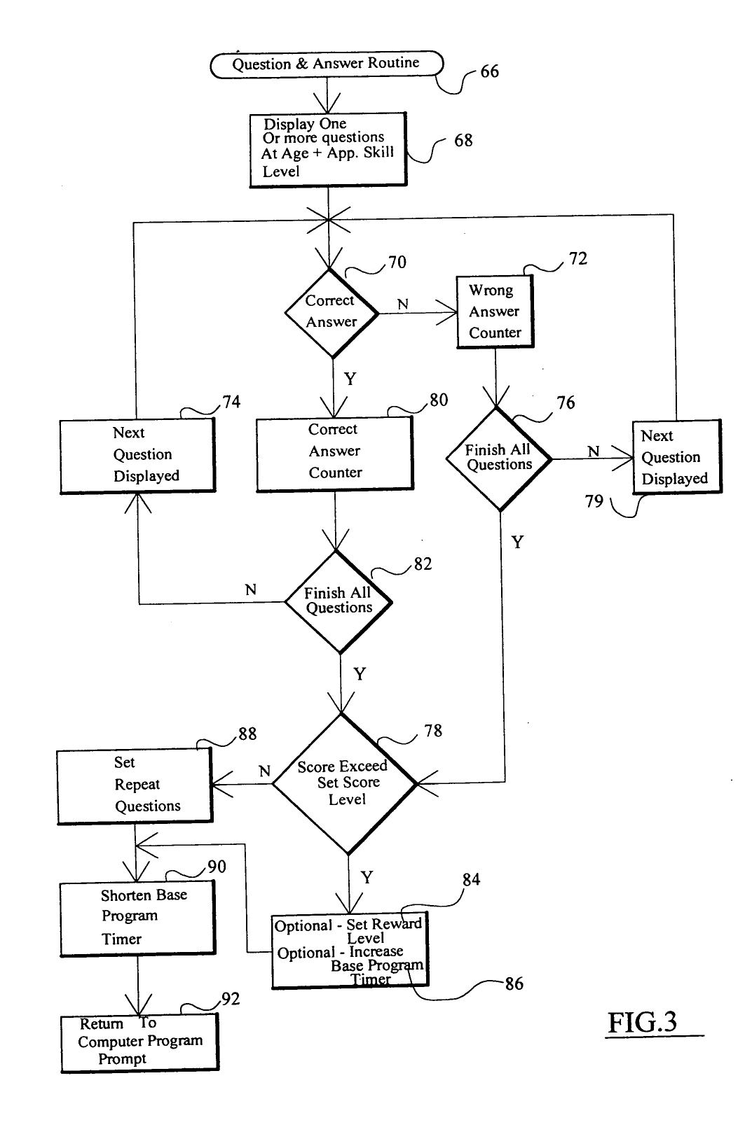

Referring to FIG. 3, a Question and Answer routine 66 is provided. The Question and Answer routine 66 provides one or more questions for display 68 and answer, wherein questions are selected based on the age of the user and/or the skill level of the user. As the questions are answered, the Question and Answer routine 66 will check the correctness of the answers 70. If the answer is incorrect, the wrong answer counter 72 will count a wrong answer. The next question will then be displayed 74. The program may present one or more “fill-in-the-blank” questions or multiple choice questions as per common software learning programs may provide.

If the user answers the question correctly 70, the correct answer counter 80 will count a correct answer. The next question will then be displayed 74. When all of the questions have been on display 82, the Question and Answer routine 66 will determine a score 78 for the list of questions. The score 78 for the list of questions is related to the total number of questions and the number of right and/or wrong answers. For example, if the total number of questions is ten, and there where eight correct answers, then a score of “8” would be given. Alternatively, the score 78 can be a ratio of the number of right or wrong answers to the total number of question. It is also contemplated that different scoring methods as know in the art can be used in the present invention.

The score 78 is compared against a score threshold. If the score 78 is greater than or equal to the score threshold the Question and Answer routine 66 can increase the skill level and optionally set a reward level 84. The reward level 84 can be an increase of the interrupt time interval, which can be increased as an increment time period, or the reward level can be an extended period of uninterrupted play, for example, one day. Additionally, the reward level 84 can print out an award certificate.

If the score 78 is less then the score threshold, the questions are set to be repeated 88. Optional, the Question and Answer routine 66 can flag the correctly answered questions, only repeating the wrongly answered questions. The scoring results are returned 92 to the II computer program 12, wherein the user is returned to the base program 16 or the base program 16 is disrupted for the set disruption interval. Additionally, the Question and Answer routine 66 can optionally decrease the interrupt time interval 90.

The Question and Answer routine 66 can further include a question timer. The question timer records that amount of time it takes the user to answer each question. A recorded answer time below a specified threshold level is an indication that the user is blindly answering the question i.e., “Christmas treeing” the answers. If the record time is below the specified threshold level, Question and Answer routine 66 will treat the answers as wrong answers, disrupting the base program for the base program 16 for the set disruption interval.

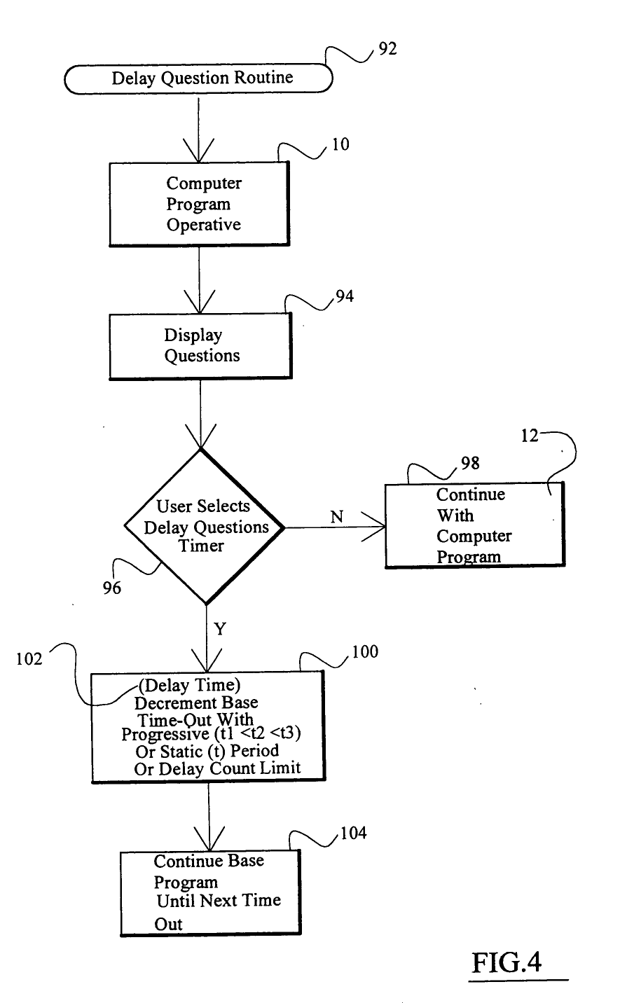

Referring to FIG. 4, a Delay Question routine 92 is provided. The Delay Question routine 92 enables the user to return to the base program 12, delaying the requirement to answer the displayed question for a set time period. At the display of the question 94 the user can optionally select the Display Question Timer 96. If the user does not select the Display Question Timer the II computer program 12 will continue 98, requiring that the displayed question be answered.

If the user selects the Display Question Timer 98, the II computer program 12 will determine 100 the delay time “t” 102. The delay time “t” 102 can be a static period, for example, five minutes. The II computer program 12 returns 104 the user back to the base program for the determined delay time 102. The questions will be redisplayed after the expiration of the delay time “t” 102.

The delay time 102 can be a progressively decreasing time period. The user can initially select the Display Question Timer 98, where the question will be delayed for a “t,” time period. If, after expiration of the “t,” timer period, the user reselects the Display Question Timer 98, the question will be delayed for a “t₂” time period, where “t₂” is less than “tₗ.” The user can continually select the Display Question Timer 98 with ever decreasing delay time periods “tₙ,” where “t₁”>“t₂”> . . . >“tₙ.”

Alternatively, the Display Question Timer 98 can include a count limiter. The count limiter limits the number of times a user can select the Display Question Timer 98. For example, if the count limiter is set to five, the user can only select the Display Question Timer 98 five times, after which the Display Question Timer 98 will no longer be available to the user. The count limiter can be per question, groups of questions, or user period.

The present invention could be produced in hardware or software, or in a combination of hardware and software, and these implementations would be known to one of ordinary skill in the art. The system, or method, according to the inventive principles as disclosed, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as a local area network (LAN) as would be known to a person of ordinary skill in the art.

According to the inventive principles as disclosed, the invention and the inventive principles are not limited to any particular kind of computer system but may be used with any general purpose computer, as would be known to a person of ordinary skill in the art, arranged to perform the functions described and the method steps described herein. The operations of such a computer, as described above, may be according to a computer program contained on a medium for use in the operation or control of the computer, as would be known to person of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM or other optical memory storage devices, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

All references cited herein are expressly incorporated by reference in their entirety.

It will be appreciated by persons skilled in the art that the present invention is not limited to what has been particularly shown and described herein above. A variety of modifications and variations are possible in light of the above teachings without departing from the scope and spirit of the invention, which is limited only by the following claims.

1. A method for intellectually stimulating a user while running a base computer program, comprising;
interrupting the base computer program;
providing at least one question to the user for answering;
receiving an answer to the at least one question; and
determining whether to return to the base program or disrupt the base program.

2. The method according to claim 1, further comprising determining an identity of the user.

3. The method according to claim 2, wherein determining the identity of the user comprises;
entering user information for storage into a user data base, wherein the user information includes a user name, a user age, and a user skill level; and
selecting the user from the user database.

4. The method according to claim 1, wherein interrupting the base computer program comprises interrupting the base computer program at a set interrupt time interval.

5. The method according to clam 4, wherein providing at least one question to the user for answering further comprises selecting the at least one question appropriate for the skill level of the user.

6. The method according to claim 5, wherein the at least one question is selected from a database comprising questions of different skill levels on at least one topic.

7. The method according to claim 5, wherein determining whether to return to the base program or disrupt the base program comprises:
checking the answer to the at least one question for correctness;
counting a number of correct answers;
counting a number of wrong answers;
providing a score; and
comparing the score to a score threshold.

8. The method according to claim 7, further comprising;
returning the user to the base computer program when the score is greater than or equal to the score threshold; and
increasing the skill level.

9. The method according to claim 8, further comprising repeating claim 1.

10. The method according to claim 8, further comprising one of decreasing or increasing the set interrupt time interval.

11. The method according to claim 7, further comprising penalizing the user when the score is greater than or equal to the score threshold.

12. The method according to claim 11, wherein penalizing the user includes disrupting the base computer program for a disruption time interval, decreasing the interruption time, or a combination thereof.

13. The method according to claim 12, further comprising returning the user to the base computer program at the expiration of the disruption time interval.

14. The method according to claim 13, further comprising repeating claim 1.

15. The method according to claim 11, further comprising repeating:
providing the at least one question to the user for answering;
receiving an answer to the at least one question; and
determining whether to return to the base program or disrupt the base program.

16. The method according to claim 1, further comprising;
providing a delay question routine, and
selecting the delay question routine, wherein the delay question routine delays providing the questions for a delay time.

17. The method according to claim 16, wherein the delay question routine can be select at least one time.

18. The method according to claim 17, wherein the delay time decrease after each selection of the delay question routine.

19. The method according to claim 17, where the delay time is a static time.

20. The method according to claim 17, wherein the question routine includes a limit counter limiting the number of times that the user can select the delay question routine.

21. The method according to claim 1, further comprising entering a bypass code to bypass the interrupting of the bas program.

22. A computer readable media comprising a method for intellectually stimulating a user while running a base computer program, the method for intellectually stimulating including:
interrupting the base computer program;
providing at least one question to the user for answering;
receiving an answer to the at least one question; and
determining whether to return to the base program or disrupt the base program.

23. The computer readable media according to claim 22, wherein the method for intellectually stimulating further includes determining an identity of the user.

24. The computer readable media according to claim 23, wherein determining the identity of the user comprises;
entering user information for storage into a user data base, wherein the user information includes a user name, a user age, and a user skill level; and
selecting the user from the user database.

25. The computer readable media according to claim 22, wherein interrupting the base computer program comprises interrupting the base computer program at a set interrupt time interval.

26. The computer readable media according to claim 25, wherein providing at least one question to the user for answering further comprises selecting the at least one question appropriate for the skill level of the user.

27. The computer readable media according to claim 26, wherein the at least one question is selected from a database comprising questions of different skill levels on at least one topic.

28. The computer readable media according to claim 26, wherein determining whether to return to the base program or disrupt the base program comprises:
checking the answer to the at least one question for correctness;
counting a number of correct answers;
counting a number of wrong answers;
providing a score; and
comparing the score to a score threshold.

29. The computer readable media according to claim 28, wherein the method for intellectually stimulating further includes;
returning the user to the base computer program when the score is greater than or equal to the score threshold; and
increasing the skill level.

30. The computer readable media according to claim 29, wherein the method for intellectually stimulating further includes repeating the method for intellectually stimulating of claim 22.

31. The computer readable media according to claim 29, wherein the method for intellectually stimulating further includes one of decreasing or increasing the set interrupt time interval.

32. The computer readable media according to claim 28, wherein the method for intellectually stimulating further includes penalizing the user when the score is greater than or equal to the score threshold.

33. The computer readable media according to claim 32, wherein penalizing the user includes disrupting the base computer program for a disruption time interval, decreasing the interruption time, or a combination thereof.

34. The computer readable media according to claim 22, wherein the method for intellectually stimulating further includes further comprising returning the user to the base computer program at the expiration of the disruption time interval.

35. The computer readable media according to claim 34, wherein the method for intellectually stimulating further includes repeating the method for intellectually stimulating of claim 22.

36. The computer readable media according to claim 22, wherein the method for intellectually stimulating further includes repeating:
providing the at least one question to the user for answering;
receiving an answer to the at least one question; and
determining whether to return to the base program or disrupt the base program.

37. The computer readable media according to claim 22, wherein the method for intellectually stimulating further includes:
providing a delay question routine, and
selecting the delay question routine, wherein the delay question routine delays providing the questions for a delay time.

38. The computer readable media according to claim 37, wherein the delay question routine can be select at least one time.

39. The computer readable media according to claim 38, wherein the delay time decrease after each selection of the delay question routine.

40. The computer readable media according to claim 38, where the delay time is a static time.

41. The computer readable media according to claim 38, wherein the question routine includes a limit counter limiting the number of times that the user can select the delay question routine.

42. The computer readable media according to claim 22, wherein the method for intellectually stimulating further includes further comprising entering a bypass code to bypass the interrupting of the bas program.

43. A computer system for intellectually stimulating a user while running a base computer program including:
means for interrupting the base computer program;
means for providing at least one question to the user for answering;
means for receiving an answer to the at least one question; and
means for determining whether to return to the base program or disrupt the base program.

44. The computer system according to claim 43, including means for determining an identity of the user.

45. The computer system according to claim 44, wherein means for determining the identity of the user comprises;
means for entering user information for storage into a user data base, wherein the user information includes a user name, a user age, and a user skill level; and
means for selecting the user from the user database.

46. The computer system according to claim 43, includng means for interrupting the base computer program at a set interrupt time interval.

47. The computer system according to claim 46, wherein said means for providing at least one question to the user for answering further comprises means for selecting the at least one question appropriate for the skill level of the user.

48. The computer system according to claim 47, wherein the at least one question is selected from a database including questions of different skill levels on at least one topic.

49. The computer system according to claim 47, wherein said means for determining whether to return to the base program or disrupt the base program comprises:
means for checking the answer to the at least one question for correctness;
means for counting a number of correct answers;
means for counting a number of wrong answers;
means for providing a score; and
means for comparing the score to a score threshold.

50. The computer system according to claim 49, including;
means for returning the user to the base computer program when the score is greater than or equal to the score threshold; and
means for increasing the skill level.

51. The computer system according to claim 50, including means for repeatingly activating said means for interrupting, providing said question, receiving said answer and determining return.

52. The computer system according to claim 50, including means for increasing the set interrupt time interval.

53. The computer system according to claim 49, including means for penalizing the user when the score is greater than or equal to the score threshold.

54. The computer system according to claim 53, wherein said means for penalizing the user includes means for disrupting the base computer program for a disruption time interval, decreasing the interruption time, or a combination thereof.

55. The computer system according to claim 54, including means for returning the user to the base computer program at the expiration of the disruption time interval.

56. The computer system according to claim 55, including means for repeating the interrupting, questioning and answering.

57. The computer system according to claim 53, including means for repeating: providing the at least one question; receiving an answer; determining whether to return.

58. The computer system according to claim 43, including:
means for providing a delay question routine, and
means for selecting the delay question routine, wherein the delay question routine delays providing the questions for a delay time.

59. The computer system according to claim 58, wherein the delay question routine can be selected at least one time.

60. The computer system according to claim 59, wherein the delay time decreases after each selection of the delay question routine.

61. The computer system according to claim 59, where the delay time is a static time.

62. The computer system according to claim 59, wherein the question routine includes a limit counter limiting the number of times that the user can select the delay question routine.

63. The computer readable media according to claim 43, including means for entering a bypass code to bypass the interrupting of the base program.
